(19) United States
(12) Patent Application Publication
(10) Pub. No.: US 2026/0177473 A1
(43) Pub. Date: Jun. 25, 2026

(54) CORROSION PREDICTION METHOD

(71) Applicant: TOYOTA JIDOSHA KABUSHIKI KAISHA, Toyota-shi (JP)

(72) Inventors: Nobuyo KONDO, Toyota-shi (JP); Hiroshi KAWAGUCHI, Okazaki-shi (JP); Yosuke SUMI, Anjo-shi (JP); Daigo ASAI, Okazaki-shi (JP); Takanori TATEMATSU, Nisshin-shi (JP); Kyo KOMURA, Kasugai-shi (JP)

(73) Assignee: TOYOTA JIDOSHA KABUSHIKI KAISHA, Toyota-shi (JP)

(21) Appl. No.: 19/294,838

(22) Filed: Aug. 8, 2025

(30) Foreign Application Priority Data
Dec. 20, 2024 (JP) 2024-225210

(51) Int. Cl. G01N 17/00

(52) U.S. Cl. CPC G01N 17/006; G01N 17/008

(57) ABSTRACT

A corrosion prediction method includes: acquiring corrosion environment data and corrosion amount data of a vehicle, the corrosion environment data including at least temperature, humidity, salt concentration, and traveling time for each road surface state; constructing a corrosion prediction model using the corrosion environment data as an explanatory variable and the corrosion amount data as an objective variable; defining an explanatory variable having a high correlation with the corrosion amount as a corrosion promoting factor; acquiring vehicle data and meteorological data; constructing a corrosion promoting factor selection model using the vehicle data and the meteorological data as explanatory variables and the corrosion promoting factor as an objective variable; inputting the vehicle data and the meteorological data of a vehicle to be predicted to the corrosion promoting factor selection model and obtaining the corrosion promoting factor; and predicting a corrosion amount of the vehicle based on the obtained corrosion promoting factor.

### CROSS-REFERENCE TO RELATED APPLICATION

This application claims priority to Japanese Patent Application No. 2024-225210 filed on Dec. 20, 2024. The disclosure of the above-identified application, including the specification, drawings, and claims, is incorporated by reference herein in its entirety.

### BACKGROUND

### 1. Technical Field

The present disclosure relates to a corrosion prediction method, and particularly to a corrosion prediction method of predicting a corrosion amount of a vehicle.

### 2. Description of Related Art

As a related art, for example, there is a technique described in EP Patent Application Publication No. 4257951. The corrosion prediction method described in EP Patent Application Publication No. 4257951 includes the following first step to fourth step. In the first step, training data in which corrosion amount data of a vehicle is associated with vehicle data and meteorological data is constructed. In the second step, the corrosion amount data of the vehicle and the meteorological data are associated by training the machine learning model on the training data. In the third step, meteorological data is input to the machine learning model, and the prediction value of a corrosion amount is output. In the fourth step, the cumulative corrosion amount received by the vehicle is estimated based on the corrosion amount prediction value that is output.

### SUMMARY

However, in the corrosion prediction method in EP Patent Application Publication No. 4257951 described above, there is an issue that the corrosion amount is difficult to be predicted with high accuracy for the following causes. First, in the corrosion prediction method described in EP Patent Application Publication No. 4257951, the machine learning model is trained with the traveling speed of the vehicle, the traveling direction of the vehicle, and the meteorological data obtained from a meteorological observatory close to the vehicle to construct a corrosion prediction model. However, there is insufficient information that contributes to the prediction of the corrosion amount, such as vehicle information other than the traveling speed and the traveling direction, snowfall, and humidity. For example, a snow melting agent applied as a road surface freezing prevention measure in a snowfall zone has sodium chloride as a main component, and thus greatly contributes to the corrosion amount of the vehicle. In addition, changes in humidity also greatly contributes to the corrosion amount. When the information described above are insufficient, the prediction accuracy of the corrosion amount is reduced.

In addition, in the corrosion prediction method described in EP Patent Application No. 4257951, a training method including an artificial neural network is adopted, so that a large volume of data is required, and a technique of shortening a data interval and increasing the volume of data is required. However, in the corrosion prediction method, since a time interval of the data is set to 1 minute to 120 minutes, the time interval is relatively short, contrary to the time required for the value of the amount of change in the data to reach a reliable magnitude. Due to the causes described above, the prediction accuracy of the corrosion amount is reduced.

The present disclosure has been made to solve the technical issue, and an object of the present disclosure is to provide a corrosion prediction method for improving the prediction accuracy of the corrosion amount.

The corrosion prediction method according to the present disclosure relates to a corrosion prediction method of predicting a corrosion amount of a vehicle. The corrosion prediction method includes
a first step of acquiring corrosion environment data of a vehicle and corrosion amount data of the vehicle, the corrosion environment data including at least a temperature, a humidity, a salt concentration, and a traveling time for each road surface state,
a second step of constructing a corrosion prediction model by performing machine learning using the corrosion environment data acquired in the first step as an explanatory variable and the corrosion amount data acquired in the first step as an objective variable, and defining an explanatory variable having a high correlation with the corrosion amount among the corrosion environment data as a corrosion promoting factor,
a third step of acquiring vehicle data including position information of the vehicle, and meteorological data based on the position information of the vehicle,
a fourth step of constructing a corrosion promoting factor selection model by performing machine learning using the vehicle data and the meteorological data acquired in the third step as explanatory variables and the corrosion promoting factor defined in the second step as an objective variable, and
a fifth step of predicting a corrosion amount of a vehicle based on the vehicle data of a vehicle to be predicted, the meteorological data based on the position information of the vehicle to be predicted, and the corrosion promoting factor selection model constructed in the fourth step.

In the corrosion prediction method according to the present disclosure, in the second step, the corrosion prediction model is constructed by performing machine learning using the corrosion environment data as the explanatory variable and the corrosion amount data as the objective variable. An explanatory variable having a high correlation with the corrosion amount among the corrosion environment data is defined as the corrosion promoting factor. In the fourth step, the machine learning is performed using the vehicle data and the meteorological data as the explanatory variables and the corrosion promoting factor as the objective variable to construct the corrosion promoting factor selection model. In this way, the vehicle data and the meteorological data can be associated with the corrosion environment data, that is, the corrosion environment data can be replaced with the vehicle data and the meteorological data. Therefore, it is possible to predict the corrosion amount of the vehicle based on the vehicle data and the meteorological data having a high correlation with the corrosion amount, and thus it is possible to reduce a lack of information for corrosion amount prediction in the related art and to improve the prediction accuracy of the corrosion amount.

In addition, in the fifth step, the corrosion amount of the vehicle is predicted based on the vehicle data of the vehicle to be predicted and the meteorological data, and the corrosion promoting factor selection model. In this way, the corrosion amount of the vehicle can be predicted by using the data having a high correlation with the corrosion amount, so that the prediction accuracy of the corrosion amount can be improved.

In the corrosion prediction method according to the present disclosure, the fifth step may be a step of
inputting the vehicle data of the vehicle to be predicted and the meteorological data based on the position information of the vehicle to be predicted into the corrosion promoting factor selection model constructed in the fourth step and obtaining the corrosion promoting factor, and
inputting the corrosion promoting factor that is obtained into the corrosion prediction model constructed in the second step and predicting the corrosion amount of the vehicle. In this way, the corrosion prediction model using the vehicle data and the meteorological data as the explanatory variables, replacing the corrosion environment data, can be used to predict the corrosion amount of the vehicle, so that the prediction accuracy can be further improved.

In the corrosion prediction method according to the present disclosure, the fifth step may be a step of extracting data having a high correlation with the corrosion amount among the vehicle data and the meteorological data based on the vehicle data and the meteorological data acquired in the third step and the corrosion promoting factor selection model constructed in the fourth step,
constructing a model by performing machine learning using the data that is extracted as an explanatory variable and the corrosion amount data acquired in the first step as an objective variable, and
inputting data having a high correlation with the corrosion amount among the vehicle data of the vehicle to be predicted and the meteorological data based on the position information of the vehicle to be predicted to the model that is constructed and predicting the corrosion amount of the vehicle. In this way, since vehicle data and meteorological data narrowed down to data relevant to the corrosion environment can be directly associated with the corrosion amount data, the corrosion amount of the vehicle can be further accurately predicted.

In the corrosion prediction method according to the present disclosure, the corrosion environment data may further include a salt adhesion amount and a traveling time for each of for each road type. In this way, a volume of corrosion environment data can be increased, so that the accuracy of the corrosion prediction model to be constructed and the accuracy of the corrosion promoting factor to be defined can be improved. As a result, the prediction accuracy of the corrosion amount can be further improved.

According to the present disclosure, the prediction accuracy of the corrosion amount can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart showing a corrosion prediction method according to a first embodiment;

FIG. 2 is a schematic diagram for illustrating the corrosion prediction method; and

FIG. 3 is a flowchart showing a corrosion prediction method according to a second embodiment.

### DETAILED DESCRIPTION OF EMBODIMENTS

Hereinafter, embodiments of a corrosion prediction method according to the present disclosure will be described with reference to the drawings. The corrosion prediction method described below embodiment is a method of predicting the corrosion amount of the vehicle. More specifically, the corrosion prediction method is for predicting the amount of corrosion caused by salt adhering to a metal component (for example, a fender panel, a door outer panel, a wheel, or the like) of a vehicle, by moisture adhering to a metal component, or by both salt and moisture adhering to a metal component.

### First Embodiment

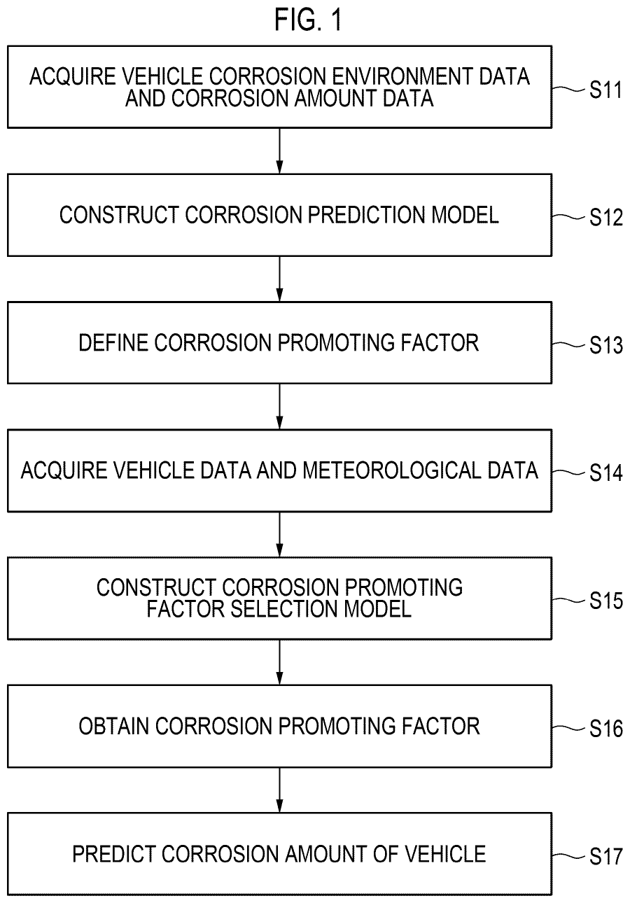

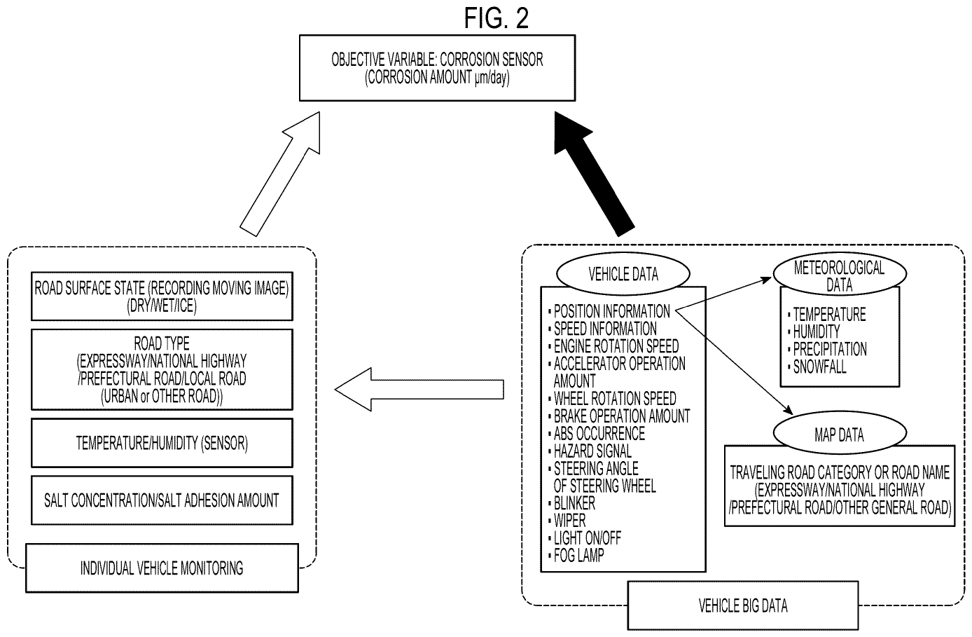

FIG. 1 is a flowchart showing a corrosion prediction method according to a first embodiment, and FIG. 2 is a schematic diagram for describing the corrosion prediction method. As shown in FIG. 1, the corrosion prediction method of the present embodiment includes acquisition S11 of vehicle corrosion environment data and corrosion amount data, construction S12 of a corrosion prediction model, definition S13 of a corrosion promoting factor, acquisition S14 of vehicle data and meteorological data, construction S15 of a corrosion promoting factor selection model, and obtaining S16 of a corrosion promoting factor, and corrosion amount prediction S17 of the vehicle.

Among the above steps, acquisition S11 of the corrosion environment data of the vehicle and the corrosion amount data may be directly performed by the computer. Alternatively, acquisition S11 may be performed by inputting the data to the computer after the worker or the like measures or collects the data. Alternatively, acquisition S11 may be performed in cooperation with a worker or the like and the computer. On the other hand, although construction S12 of the corrosion prediction model to corrosion amount prediction S17 of the vehicle are performed by the computer, it is not always necessary to perform the construction and the prediction on the same computer.

Although not shown, the computer constitutes, for example, a corrosion prediction device. The computer includes an input unit that receives data input, a central processing unit (CPU) that executes an operation, a read only memory (ROM) as a secondary storage device that records a program for the operation, a random access memory (RAM) as a temporary storage device that stores a progress of the operation and a temporary control variable, and the like. The computer executes the processing including the above steps by executing the stored program.

Acquisition S11 of the vehicle corrosion environment data and the corrosion amount data corresponds to the “first step” described in the claims. In acquisition S11 of the corrosion environment data of the vehicle and the corrosion amount data, the corrosion environment data of the vehicle including at least the temperature, the humidity, the salt concentration, and the traveling time for each road surface state, and the corrosion amount data of the vehicle are acquired. In the present embodiment, the corrosion environment data of the vehicle includes the temperature, the humidity, the salt concentration, and the traveling time for each road surface state, and further includes the salt adhesion amount and the traveling time for each road type.

The vehicle corrosion environment data is obtained, for example, by individual vehicle monitoring shown in FIG. 2. Specifically, the temperature and the humidity are acquired by, for example, attaching a thermometer and a hygrometer to the vehicle and measuring the temperature and the humidity. The salt concentration is acquired, for example, by measuring droplets adhered to a vehicle with a salt concentration meter. The salt adhesion amount is acquired, for example, by wiping off the salt adhered to the vehicle and measuring the amount of the wiped-off salt. The salt concentration and the salt adhesion amount are preferably measured after the vehicle travels every day.

The traveling time for each road surface state is acquired, for example, as follows. The road surface state of the road surface on which the vehicle travels is classified into DRY, WET, and ICE by image analysis with respect to the image recorded by the dashboard camera attached to the vehicle. Thereafter, the traveling time for each of DRY, WET, and ICE is calculated. The traveling time for each road surface state is preferably calculated every day.

The traveling time for each road type is acquired by, for example, classifying the road type on which the vehicle travels every day into an expressway, a national highway, a prefectural road, and a local road (urban or other general road), and calculating the traveling time for each of the expressway, the national highway, the prefectural road, and the local road. The reason for classifying in this way is that, for example, the snow melting agent is more frequently sprayed on the expressway than on the local road in the snowfall zone.

On the other hand, the corrosion amount of the vehicle is acquired, for example, by attaching a corrosion sensor to the vehicle and measuring the corrosion amount with the corrosion sensor. Examples of the corrosion sensor include an electric resistance corrosion sensor (RCM sensor) and a wireless corrosion monitoring system Aircorr. The corrosion amount data is preferably divided into a corrosion change amount (unit: μm/day) for each day.

Construction S12 of the corrosion prediction model and definition S13 of the corrosion promoting factor correspond to the “second step” described in the claims. In construction S12 of the corrosion prediction model, the corrosion environment data acquired in acquisition S11 of the corrosion environment data and the corrosion amount data of the vehicle is used as an explanatory variable, and machine learning is performed with the corrosion amount data as an objective variable to construct the corrosion prediction model.

Specifically, first, each data related to the temperature, the humidity, the salt concentration, the salt adhesion amount, the traveling time for each road surface state, and the traveling time for each road type is used as an explanatory variable, and the corrosion amount data is used as an objective variable to create labeled data. The machine learning is performed using random forest on the created labeled data (that is, the relationship between each explanatory variable and the objective variable is machine-learned using random forest) to construct the corrosion prediction model.

In definition S13 of the corrosion promoting factor, the explanatory variable having a high correlation with the corrosion amount among the corrosion environment data is defined as the corrosion promoting factor. Specifically, an item having a high correlation with the corrosion amount is selected from among the temperature, the humidity, the salt concentration, the salt adhesion amount, the traveling time for each road surface state, and the traveling time for each road type, by using the corrosion prediction model constructed in construction S12 of the corrosion prediction model. The selected item is defined as a corrosion promoting factor.

Acquisition S14 of the vehicle data and the meteorological data corresponds to the “third step” described in the claims. In acquisition S14 of the vehicle data and the meteorological data, the vehicle data including the position information of the vehicle and the meteorological data based on the position information of the vehicle are acquired, respectively. As shown in FIG. 2, the vehicle data is, for example, a part of the vehicle big data. The vehicle data includes position information of the vehicle, speed information, an engine rotation speed, an accelerator operation amount, a wheel rotation speed, a brake operation amount, ABS occurrence, a hazard signal, a steering angle of a steering wheel, a blinker, a wiper, light-on, a fog lamp, and the like.

The vehicle data is, for example, connected data collected from a connected car, and includes navigation probe data and controller area network (CAN) data. The navigation probe data is data including position information, speed information, and the like generated by a navigation system mounted on a vehicle. The CAN data is data obtained by communication (wired or wireless, or both wired and wireless) between a large number of electronic control units (ECUs) mounted on the vehicle and accumulated. The CAN data has data related to behavior of the vehicle, such as running, turning, and stopping, and data related to the vehicle state, such as operation of a wiper and a light.

The vehicle data is acquired by the computer through communication (wired or

wireless, or both wired and wireless) and stored in the storage device. In the present embodiment, the vehicle data is acquired from a cloud (for example, a data center) via a data communication module (DCM) of a wireless communication module, and is stored.

In addition, as shown in FIG. 2, the vehicle big data includes meteorological data, map data, and the like in addition to the vehicle data. The meteorological data is obtained from a meteorological observatory closest to the vehicle based on the position information of the vehicle. The meteorological data includes, for example, temperature, humidity, precipitation, and snowfall.

The map data includes, for example, a traveling road category or a road name, and includes, for example, an expressway (a national expressway or an expressway), a national highway, a prefectural road, and other general roads. Therefore, the type of the road on which the vehicle travels can be acquired from the map data based on the position information of the vehicle.

Construction S15 of the corrosion promoting factor selection model corresponds to the “fourth step” described in the claims. In construction S15 of the corrosion promoting factor selection model, the vehicle data and the meteorological data acquired in acquisition S14 of the vehicle data and the meteorological data acquired in acquisition S14 are used as explanatory variables, and the corrosion promoting factor defined in definition S13 of the corrosion promoting factor is used as an objective variable. By performing machine learning using the explanatory variables and the objective variable, a corrosion promoting factor selection model is constructed.

Specifically, the labeled data in which the vehicle data and the meteorological data are used as the explanatory variables and the corrosion promoting factor is used as the objective variable is created, and the machine learning is performed by random forest on the created labeled data to construct the corrosion promoting factor selection model. As a result, the vehicle data and the meteorological data can be associated with the corrosion environment data.

Obtaining S16 of the corrosion promoting factor and corrosion amount prediction S17 of the vehicle correspond to the “fifth step” described in the claims. In obtaining S16 of the corrosion promoting factor, the corrosion amount of the vehicle is predicted based on the vehicle data of the vehicle to be predicted, the meteorological data based on the position information of the vehicle to be predicted, and the corrosion promoting factor selection model constructed in construction S15 of the corrosion promoting factor selection model. More specifically, first, vehicle data of any vehicle to be predicted and meteorological data based on position information of the vehicle are acquired. Next, the acquired vehicle data and the meteorological data are input to the constructed corrosion promoting factor selection model to obtain the corrosion promoting factor among the corrosion environment data.

Next, in corrosion amount prediction S17 of the vehicle, the corrosion promoting factor obtained in obtaining S16 of the corrosion promoting factor is input to the corrosion prediction model constructed in construction S12 of the corrosion prediction model, and a prediction value of the corrosion amount of the vehicle is calculated.

In the corrosion prediction method according to the present embodiment, in construction S12 of the corrosion prediction model, the corrosion prediction model is constructed by performing machine learning using the corrosion environment data as the explanatory variable and the corrosion amount data as the objective variable. In definition S13 of the corrosion promoting factor, the explanatory variable having a high correlation with the corrosion amount among the corrosion environment data is defined as the corrosion promoting factor. Further, in construction S15 of the corrosion promoting factor selection model, the corrosion promoting factor selection model is constructed by performing machine learning using the vehicle data and the meteorological data as explanatory variables and the corrosion promoting factor as an objective variable. In this way, the vehicle data and the meteorological data can be associated with the corrosion environment data, that is, the corrosion environment data can be replaced with the vehicle data and the meteorological data. As a result, it is possible to predict the corrosion amount of the vehicle based on the vehicle data and the meteorological data having a high correlation with the corrosion amount, and thus it is possible to prevent the lack of information contributing to the corrosion amount prediction as in the related art and to improve the prediction accuracy of the corrosion amount. Moreover, since the data having a high correlation with the corrosion amount (in other words, the data that highly contributes to the corrosion amount prediction) is selected to predict the corrosion amount of the vehicle, the prediction accuracy of the corrosion amount can be improved.

In addition, in obtaining S16 of the corrosion promoting factor, the vehicle data and the meteorological data of the vehicle to be predicted are input to the corrosion promoting factor selection model to obtain the corrosion promoting factor among the corrosion environment data. In corrosion amount prediction S17 of the vehicle, the obtained corrosion promoting factor is input to the corrosion prediction model to predict the corrosion amount of the vehicle. In this way, the corrosion prediction model using the vehicle data and the meteorological data as the explanatory variables instead of the corrosion environment data can be used to predict the corrosion amount of the vehicle, so that the prediction accuracy can be improved.

In addition, in the corrosion prediction method according to the present embodiment, since the vehicle data, the meteorological data, the corrosion environment data, and the corrosion amount data having a large volume of data and a value of the amount of change in the data can be used, the prediction accuracy of the corrosion amount can be further improved as compared with the related art.

### Second Embodiment

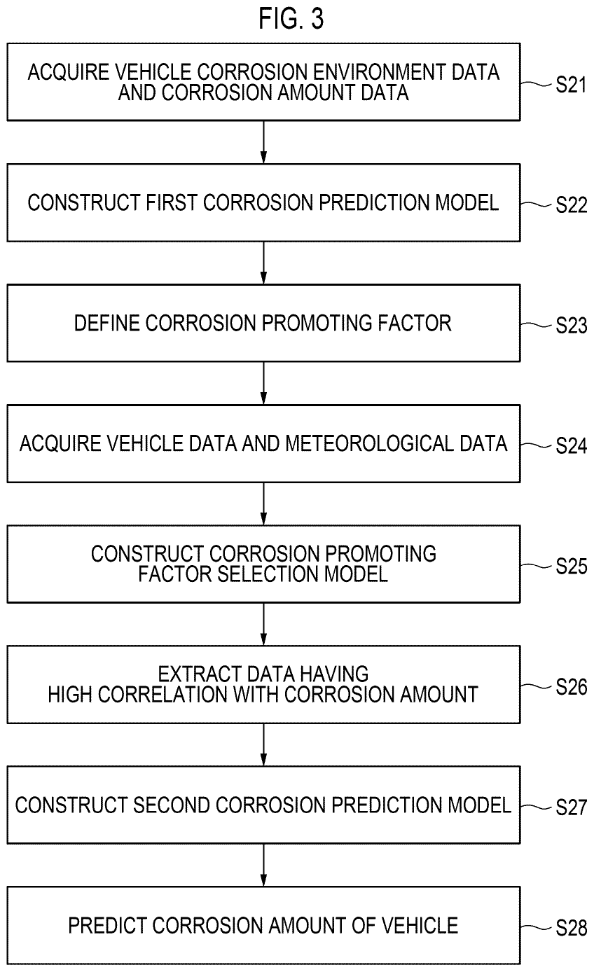

Hereinafter, a second embodiment of the corrosion prediction method will be described with reference to FIG. 3. A corrosion prediction method according to the second embodiment is different from the first embodiment in that, instead of obtaining S16 of the corrosion promoting factor and corrosion amount prediction S17 of the vehicle in the first embodiment, extraction S26 of data having a high correlation with the corrosion amount, construction S27 of the second corrosion prediction model, and corrosion amount prediction S28 of the vehicle are included. Since the other configurations are the same as those of the first embodiment, the description thereof will be omitted.

As shown in FIG. 3, the corrosion prediction method of the present embodiment includes acquisition S21 of the vehicle corrosion environment data and corrosion amount data, construction S22 of a first corrosion prediction model, definition S23 of a corrosion promoting factor, acquisition S24 of vehicle data and meteorological data, construction S25 of a corrosion promoting factor selection model, extraction S26 of data having a high correlation with the corrosion amount, construction S27 of a second corrosion prediction model, and corrosion amount prediction S28 of the vehicle.

Acquisition S21 of the corrosion environment data of the vehicle and the corrosion amount data to construction S25 of the corrosion promoting factor selection model are the same as acquisition S11 of the corrosion environment data of the vehicle and the corrosion amount data to construction S15 of the corrosion promoting factor selection model described in the first embodiment. However, in order to distinguish the corrosion prediction model described in construction S22 of the first corrosion prediction model from the corrosion prediction model described in construction S27 of the second corrosion prediction model, the corrosion prediction model constructed in construction S22 of the first corrosion prediction model is referred to as the first corrosion prediction model. The first corrosion prediction model is the same as the corrosion prediction model of the first embodiment.

Extraction S26 of data having a high correlation with the corrosion amount to corrosion amount prediction S28 of the vehicle correspond to the “fifth step” described in the claims. First, in extraction S26 of data having a high correlation with the corrosion amount, data having a high correlation with the corrosion amount is extracted among the vehicle data and the meteorological data acquired in acquisition S24 of the vehicle data and the meteorological data and the corrosion promoting factor selection model constructed in construction S25 of the corrosion promoting factor selection model, based on the vehicle data and the meteorological data.

For example, among the vehicle data, the speed of the vehicle, the accelerator operation amount, and the brake operation amount are related to the water coverage when the vehicle travels on the WET road surface, so that the data of the speed of the vehicle, the accelerator operation amount, and the brake operation amount is extracted. On the other hand, among the meteorological data, the temperature, the humidity, and the precipitation are related to the progress of corrosion, and the snowfall is related to the spraying of the snow melting agent, so that the data of the temperature, the humidity, the precipitation, and the snowfall are extracted.

In construction S27 of the second corrosion prediction model, the data extracted in extraction S26 of the data having a high correlation with the corrosion amount is used as an explanatory variable, and the machine learning is performed using the corrosion amount data acquired in acquisition S21 of the vehicle corrosion environment data and the corrosion amount data as an objective variable. The second corrosion prediction model is constructed by the machine learning.

Specifically, the vehicle data and the meteorological data having a high correlation with the corrosion amount extracted in extraction S26 are used as explanatory variables, and the vehicle corrosion environment data and the corrosion amount data acquired in acquisition S21 are used as an objective variable to create the labeled data. The second corrosion prediction model is constructed by performing machine learning on the created labeled data.

Next, in corrosion amount prediction S28 of the vehicle, first, the meteorological data based on the vehicle data of the vehicle to be predicted and the position information of the vehicle to be predicted is acquired. Next, in the same manner as extraction S26 of the data having a high correlation with the corrosion amount with respect to the acquired vehicle data of the vehicle to be predicted and the meteorological data, the data having a high correlation with the corrosion amount is extracted among the data. Next, the extracted data (that is, the vehicle data and the meteorological data having a high correlation with the corrosion amount of the vehicle to be predicted) is input to the second corrosion prediction model constructed in construction S27 of the second corrosion prediction model, and a prediction value of the corrosion amount is calculated.

With the corrosion prediction method according to the present embodiment, in addition to the same effects as those of the first embodiment described above, extraction S26 of data having a high correlation with the corrosion amount and corrosion amount prediction S28 of the vehicle are included, so that the following effects can be further obtained.

That is, in extraction S26 of data having a high correlation with the corrosion amount, data having a high correlation with the corrosion amount is extracted among the vehicle data and the meteorological data acquired in acquisition S24 of the vehicle data and the meteorological data based on the corrosion promoting factor selection model. In construction S27 of the second corrosion prediction model, the second corrosion prediction model is constructed by performing machine learning using the extracted data as the explanatory variable and the corrosion amount data as the objective variable. In corrosion amount prediction S28 of the vehicle, the data having a high correlation with the corrosion amount among the meteorological data based on the vehicle data of the vehicle to be predicted and the position information of the vehicle to be predicted is input to the second corrosion prediction model to predict the corrosion amount of the vehicle. In this way, since vehicle data and meteorological data filtered based on relevance to the corrosion environment can be directly associated with the corrosion amount data, the corrosion amount of the vehicle can be further accurately predicted.

Although the embodiments of the present disclosure have been described in detail above, the present disclosure is not limited to the above embodiments, and various design changes can be made within the scope of the spirit of the present disclosure described in the claims.

What is claimed is:

1. A corrosion prediction method of predicting a corrosion amount of a vehicle, the corrosion prediction method comprising:
a first step of acquiring corrosion environment data of a vehicle and corrosion amount data of the vehicle, the corrosion environment data including at least a temperature, a humidity, a salt concentration, and a traveling time for each road surface state;
a second step of constructing a corrosion prediction model by performing machine learning using the corrosion environment data acquired in the first step as an explanatory variable and the corrosion amount data acquired in the first step as an objective variable, and defining an explanatory variable having a high correlation with the corrosion amount among the corrosion environment data as a corrosion promoting factor;
a third step of acquiring vehicle data including position information of the vehicle, and meteorological data based on the position information of the vehicle;
a fourth step of constructing a corrosion promoting factor selection model by performing machine learning using the vehicle data and the meteorological data acquired in the third step as explanatory variables and the corrosion promoting factor defined in the second step as an objective variable; and
a fifth step of predicting a corrosion amount of a vehicle based on the vehicle data of a vehicle to be predicted, the meteorological data based on the position information of the vehicle to be predicted, and the corrosion promoting factor selection model constructed in the fourth step.

2. The corrosion prediction method according to claim 1, wherein the fifth step is a step of:
inputting the vehicle data of the vehicle to be predicted and the meteorological data based on the position information of the vehicle to be predicted into the corrosion promoting factor selection model constructed in the fourth step and obtaining the corrosion promoting factor; and
inputting the corrosion promoting factor that is obtained into the corrosion prediction model constructed in the second step and predicting the corrosion amount of the vehicle.

3. The corrosion prediction method according to claim 1, wherein the fifth step is a step of:
extracting data having a high correlation with the corrosion amount among the vehicle data and the meteorological data based on the vehicle data and the meteorological data acquired in the third step and the corrosion promoting factor selection model constructed in the fourth step;
constructing a model by performing machine learning using the data that is extracted as an explanatory variable and the corrosion amount data acquired in the first step as an objective variable; and
inputting data having a high correlation with the corrosion amount among the vehicle data of the vehicle to be predicted and the meteorological data based on the position information of the vehicle to be predicted to the model that is constructed and predicting the corrosion amount of the vehicle.

4. The corrosion prediction method according to claim 1, wherein the corrosion environment data further includes a salt adhesion amount and a traveling time for each road type.
